(19) United States
(12) Patent Application Publication
(10) Pub. No.: US 2013/0279228 A1
(43) Pub. Date: Oct. 24, 2013

(54) SYSTEM AND METHOD FOR IMPROVING LOW-LOAD EFFICIENCY OF HIGH POWER CONVERTERS

(71) Applicants: Huibin Zhu, Westford, MA (US); Robert Gregory Wagoner, Roanoke, VA (US); David Scott Wilmer, Troutville, VA (US)

(72) Inventors: Huibin Zhu, Westford, MA (US); Robert Gregory Wagoner, Roanoke, VA (US); David Scott Wilmer, Troutville, VA (US)

(73) Assignee: GENERAL ELECTRIC COMPANY, Schenectady, NY (US)

(21) Appl. No.: 13/453,257

(22) Filed: Apr. 23, 2012

(51) Int. Cl. H02M 7/5387

(52) U.S. Cl. 363/132

(57) ABSTRACT

Systems and methods for improving low-load efficiency of power converters are provided. The power converter can include one or more bridge circuits having multiple switching modules, such as insulated gate bipolar transistor (IGBT) modules, connected in parallel within the same bridge circuit. The power converter is configured to convert power from an input power source, such as a photovoltaic array or a wind turbine, into output power at a grid frequency. To avoid excessive switching losses at low load conditions, the power converter can be controlled to selectively operate a subset of the switching modules within the same bridge circuit based on a load condition for the power converter. The remaining switching modules in the bridge circuit can be disabled.

### FIELD OF THE INVENTION

The present disclosure relates generally to renewable energy sources, and more particularly to a system and method for improving low-load efficiency of power converters used in renewable energy applications.

### BACKGROUND OF THE INVENTION

Power converters are used in renewable energy applications to convert electrical power generated by a renewable energy source into power that is suitable for supply to an AC grid. For example, power converters can be used in wind energy applications to convert the alternating current generated by a wind turbine to a desired output frequency (e.g. 50/60 Hz) and voltage level. Power converters can be used in solar energy applications to convert the DC power generated by one or more photovoltaic arrays into suitable AC power for the AC grid.

Power converters can be subject to stringent efficiency requirements at various voltages. The efficiency of the power converter can refer to a ratio of output power to input power for the power converter. Typical power converters can be operated at a relatively high efficiency when operated at high loads. However, the efficiency of the power converters can drop significantly when the power converters are operated at low loads. For example, FIG. 1 depicts the efficiency of two exemplary solar power converters at different load conditions. As illustrated by curves 50 and 60, the efficiency of the power converters at high load conditions can be above 97%. However, as the load condition drops to less than about 50% of rated output power for the power converter, the efficiency of the power converter drops significantly. For instance, the power converters can have efficiencies in the range of 90-92% at about 10% of the rated output power.

A primary reason for the efficiency loss at low loads can be due to the increased switching losses associated with switching devices (e.g. Insulated Gate Bipolar Transistors (IGBTs)) used in the power converter. This efficiency loss is increased with high power converters, such as power converters rated up to 1 MW. Typical large IGBT modules cannot switch fast and safely in circuit operation. Accordingly, multiple smaller IGBT modules are used in parallel to achieve the required high power level for high power converters. This leads to an increased number of IGBTs and thus increased switching losses.

Thus, a need exists for a system and method to improve the low-load efficiency of power converters used in high power renewable energy applications.

### BRIEF DESCRIPTION OF THE INVENTION

Aspects and advantages of the invention will be set forth in part in the following description, or may be obvious from the description, or may be learned through practice of the invention.

One exemplary aspect of the present disclosure is directed to a power converter system. The power converter system includes a power converter couplable (e.g. capable of being coupled to) to an input power source and configured to generate an output power substantially at a grid frequency. The power converter includes an inverter bridge circuit associated with an output phase of the power converter. The inverter bridge circuit includes a plurality of switching modules coupled in parallel. The power converter system further includes a control system configured to control the plurality of switching modules in the at least one inverter bridge circuit. The control system is configured to selectively operate a subset of the plurality of switching modules in the inverter bridge circuit based on a load condition for the power converter.

Another exemplary aspect of the present disclosure is directed to a method of increasing the efficiency of a power converter at a low load condition for the power converter. The method includes providing an inverter input to an inverter bridge circuit of the power converter. The inverter bridge circuit can be associated with an output phase of the power converter and can include a plurality of switching modules connected in parallel. The method further includes converting the inverter input to an output power substantially at a grid frequency and at a load condition that is less than the rated output power for the power converter. Converting the inverter input to an output power at a load condition that is less than the rated output power for the power converter includes selectively operating a subset of the plurality of switching modules of the inverter bridge circuit.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts a graphical representation of the efficiency of exemplary solar power converters at various load conditions;

FIG. 2 depicts an exemplary power converter system according to an exemplary embodiment of the present disclosure;

FIG. 3 depicts a circuit diagram of an exemplary inverter for a two-stage power converter according to an exemplary embodiment of the present disclosure;

FIG. 4 depicts a circuit diagram of an exemplary DC to DC converter for a two-stage power converter according to an exemplary embodiment of the present disclosure;

FIG. 5 depicts a flow diagram of an exemplary method according to an exemplary embodiment of the present disclosure;

FIGS. 6-9 depict exemplary activation of a subset of switching modules in a bridge circuit according to exemplary embodiments of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to systems and methods for improving the efficiency of power converters used to convert energy generated by a renewable power source such as a photovoltaic array or a wind turbine, at reduced load conditions. High power converters, such as power converters rated at about 1 MW output power, typically include multiple switching modules, such as insulated gate bipolar transistor (IGBT) modules, connected in parallel within the same bridge circuit. To avoid excessive switching losses at low load conditions, the power converter can be controlled to selectively operate a subset of the switching modules within the same bridge circuit. A subset of the switching modules refers to one or more switching modules within the same bridge circuit, but less than all of the switching modules within the bridge circuit.

In a particular implementation, each switching module in a bridge circuit can be associated with an independent driver circuit. A control system associated with the power converter can selectively operate a subset of the switching modules using the independent driver circuits for the switching modules. The remaining switching modules in the bridge circuit can be disabled.

According to aspects of the present disclosure, a control system associated with the power converter can be configured to selectively operate a subset of the plurality of switching modules in the inverter bridge circuit based on a load condition for the power converter. For instance, the control system can operate a subset of the switching modules within the bridge circuit when the power converter is operated at a reduced load condition, such as at a load condition of less than about 50% of the rated power output of the power converter.

In a particular embodiment, the number of switching modules selectively operated in the bridge circuit can be dependent on the load condition of the power converter. For instance, a control system can determine based on a desired load condition the number of switching modules to operate to achieve the load condition. The number of switching modules can be selected to be the number of switching modules that most closely correlates to the desired load condition. As one example, the control system can be configured to operate about 50% or less of the switching modules in a bridge circuit when the load condition of the power converter is at about 50% or less of the rated output power for the power converter. As another example, the control system can be configured to operate about 33% or less of the switching modules in a bridge circuit when the load condition of the power converter is at about 33% or less of the rated output power for the power converter.

According to another exemplary aspect of the present disclosure, the control system can be configured to selectively control a different subset of the switching modules in a bridge circuit at every fixed or predetermined time interval. For example, the control system can be configured to operate a first switching module of a bridge circuit for a first time interval and to operate a second switching module of the bridge circuit for a second time interval, with the control system switching back and forth between the first switching module and the second switching module at the expiration of every time interval.

As a result of the selectively operating only a subset of the switching modules, the switching losses incurred during operation of the power converter are reduced. For instance, in the case of an exemplary bridge circuit having two switching modules coupled in parallel, selectively operating only one of the switching modules while completely deactivating the other switching module can reduce switching losses associated with the bridge circuit by about 50%. Similarly, in the case of an exemplary bridge circuit having three switching modules coupled in parallel, selectively operating only one of the three switching modules can reduce the switching losses associated with the bridge circuit by about 66%. The reduced switching losses lead to increased efficiency of the power converter during low load conditions.

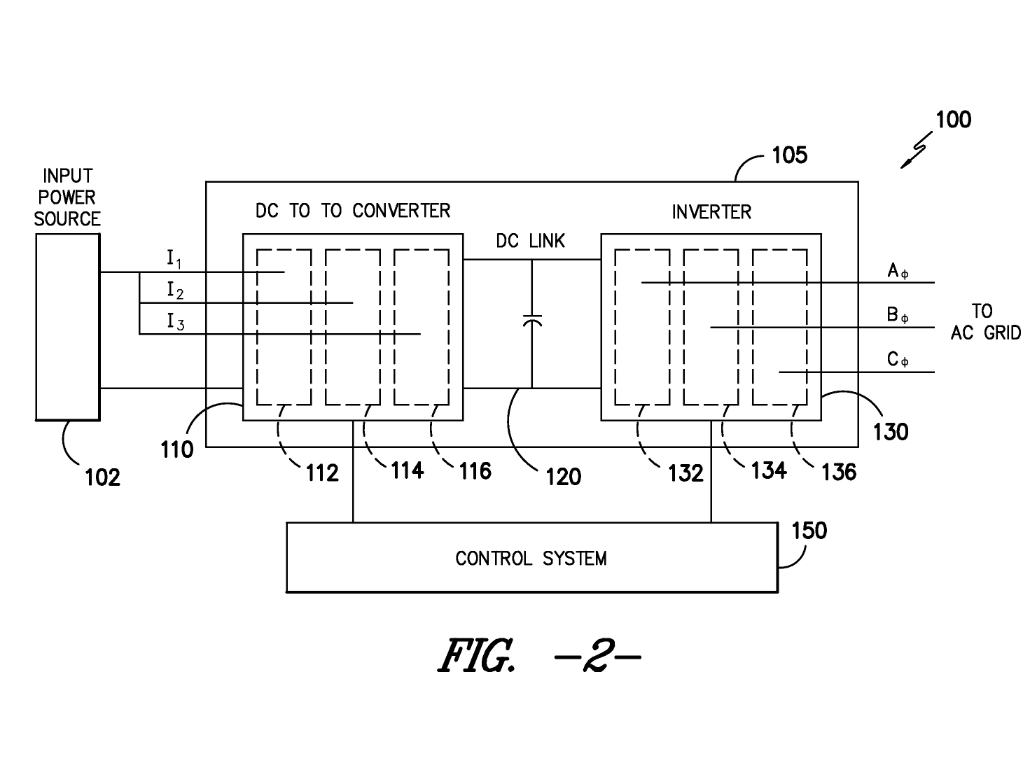

FIG. 2 depicts a block diagram of an exemplary power converter system 100 according to an exemplary aspect of the present disclosure. The power converter system 100 can be used to convert power generated by an input power source 102, such as a photovoltaic array, to AC power substantially at a grid frequency (e.g. within 10% of 50/60 Hz) suitable for supply to an AC grid. While the present disclosure will be discussed with reference to a power converter configured to convert energy generated by a photovoltaic array, those of ordinary skill in the art, using the disclosures provided herein, should understand that the power converter can similarly be used to convert power supplied from other energy sources, such as a wind turbine.

The power converter system 100 includes a power converter 105 and a control system 150 configured to control operation of the power converter 105. The power converter 105 is used to convert DC power generated by one or more photovoltaic array(s) 102 into AC power suitable for feeding to the AC grid. The power converter 105 depicted in FIG. 2 is a two-stage power converter that includes a DC to DC converter 110 and an inverter 130.

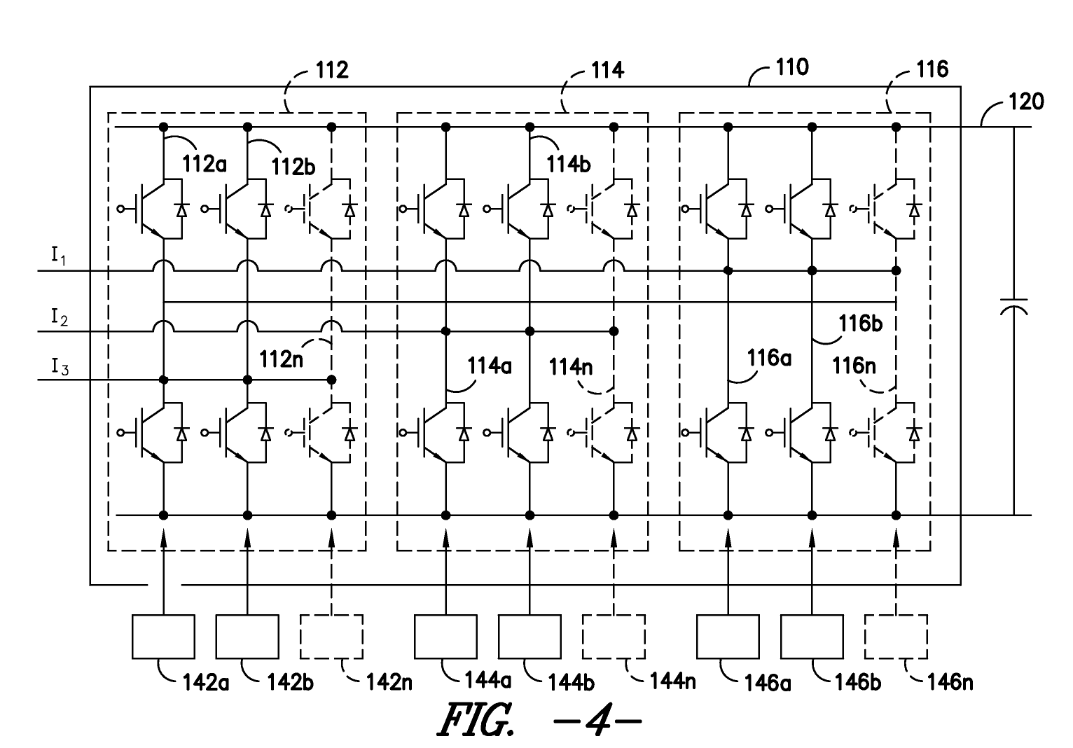

The DC to DC converter 110 can be a boost converter configured to boost the DC voltage supplied by the PV array(s) and provide the DC voltage to a DC link 120. The DC link 120 couples the DC to DC converter 110 to the inverter 130. As illustrated, the DC to DC converter 110 can include one or more bridge circuits 112, 114, and 116 that include a plurality of switching modules used to generate the DC power provided to the DC link 120. Each of the plurality of input bridge circuits 112, 114, and 116 can be associated with an input feed line to the DC to DC converter 110. As will be discussed with reference to FIG. 4 below, each of the input bridge circuits 112, 114, and 116 can include a plurality of switching modules, such as insulated gate bipolar transistor (IGBT) modules, coupled in parallel to provide increased power output. DC to DC converter 110 can be a part of or integral with inverter 130 or can be a separate stand alone structure. In addition, more than one DC to DC converter 110 can be coupled to the same inverter 130 through one or more DC links.

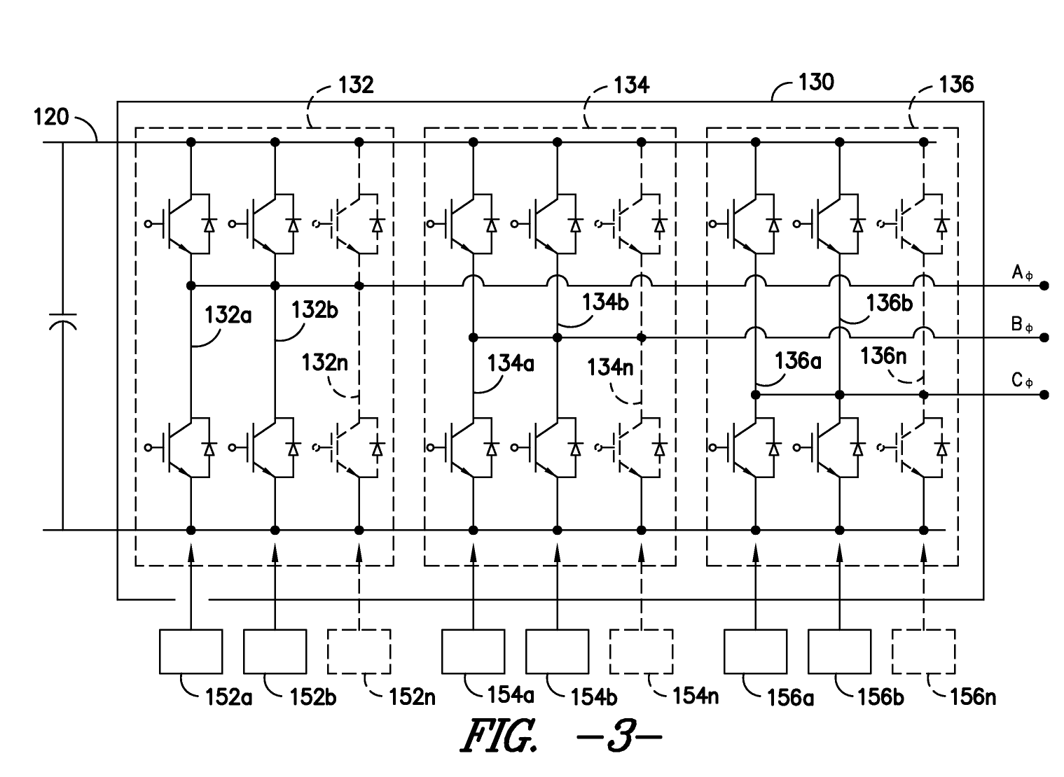

Referring to FIG. 2, the inverter 130 converts the DC power provided to the DC link 120 into AC power at a grid frequency suitable for feeding to the AC grid. The inverter 130 can be configured to provide a multiphase output, such as a three-phase output to the AC grid. The inverter 130 can include a plurality of inverter bridge circuits 132, 134, and 136. Each of the plurality of inverter bridge circuits 132, 134, and 136 can be associated with an output phase of the power converter 105. As will be discussed with reference to FIG. 3 below, each of the plurality of inverter bridge circuits can include a plurality of switching modules, such as IGBT modules, coupled in parallel to provide an increased power output.

Control system 150 can include one or more controllers or other control devices configured to control various components of the power converter system 100, including both the DC to DC converter 110 and the inverter 130. For instance, as will be discussed in more detail below, the control system 150 can send commands to the DC to DC converter 110 to regulate the output of the DC to DC converter 110 pursuant to a control method that regulates the duty cycles of switching elements (e.g. IGBTs or other power electronic devices) used in the DC to DC converter 110. Control system 150 can also regulate the output of inverter 130 by varying modulation commands provided to the inverter 130. The modulation commands control the pulse width modulation provided by switching devices (e.g. IGBTs or other power electronic devices) to provide a desired real and/or reactive output by the inverter 130.

Control system 150 can also be used to control various other components of the power converter system 100, such as circuit breakers, disconnect switches, and other devices to control operation of the power converter system 100. The control system 150 can include any number of control device(s) such as processor(s), microcontroller(s), microcomputer(s), programmable logic controller(s), application specific integrated circuit(s) or other suitable control device(s).

FIG. 3 depicts a circuit diagram of an exemplary inverter 130 of the power converter system 100. As shown, inverter 130 includes a plurality of inverter bridge circuits 132, 134, and 136 that include power electronic devices that are used to convert DC power from the DC link 120 to output AC power at a grid frequency for supply to the AC grid. Each inverter bridge circuit 132, 134, and 136 is associated with an output phase of the inverter 130. For instance, inverter bridge circuit 132 is associated with the A output of the inverter 130. Inverter bridge circuit 134 is associated with the B output of the inverter 130. Inverter bridge circuit 136 is associated with C output of the inverter 130.

Each inverter bridge circuit 132, 134, and 136 includes a plurality of switching modules (e.g. IGBT modules) coupled in parallel. For instance, inverter bridge circuit 132 includes switching modules 132a, 132b, up to 132n switching modules coupled in parallel. Switching module 132n is illustrated in dashed line to represent that any number of switching modules up to 132n can be connected in parallel for each bridge circuit. For instance, the inverter bridge circuit 132 can include two switching modules in certain applications or six switching modules other applications. Similar to inverter bridge circuit 132, inverter bridge circuit 134 includes switching modules 134a, 134b, up to 134n switching modules coupled in parallel. Inverter bridge circuit 136 includes switching modules 136a, 136b, up to 136n switching modules coupled in parallel.

Each switching module includes a pair of switching elements (e.g. IGBTs) coupled in series with one another. A diode can be coupled in parallel with each of the individual switching elements. The output of the switching module is coupled to the switching module at a location between the pair of switching elements.

As illustrated, each switching module has its own dedicated driver circuit for controlling the switching elements in the switching module. For instance, switching modules 132a, 132b, . . . 132n each have an associated driver circuit 152a, 152b, . . . 152n. Switching modules 134a, 134b, . . . 134n each have an associated driver circuit 154a, 154b, . . . 154n. Switching modules 136a, 136b, . . . 136n each have an associated driver circuit 156a, 156b, . . . 156n.

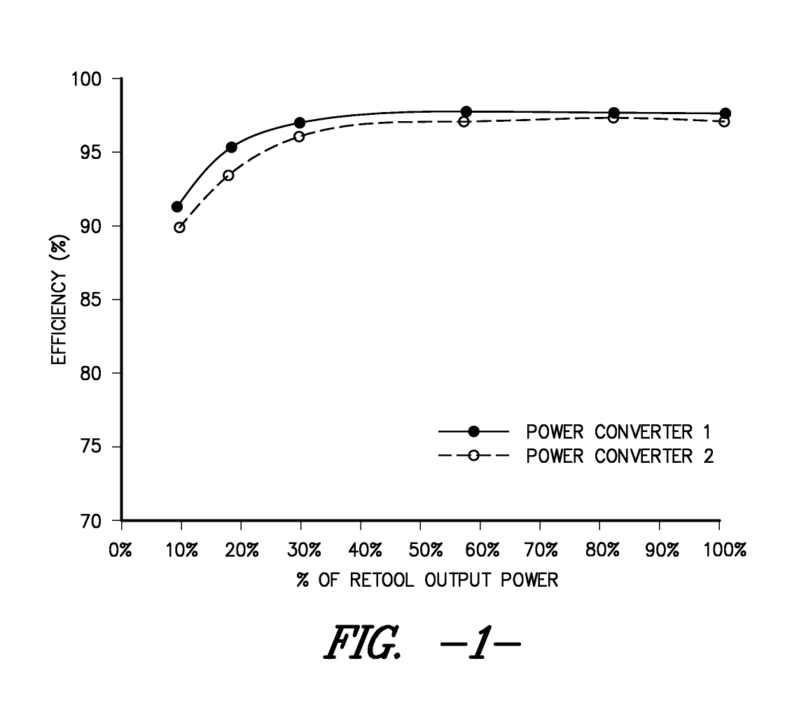

Each driver circuit can be configured to provide gate timing commands to its associated switching module to achieve a desired output for the inverter 130. For instance, the driver circuits can be used to implement gate commands from the control system 150 (shown in FIG. 1) to synthesize an AC output at the AC grid frequency using pulse width modulation techniques of the switching devices used in the switching modules. As will be discussed in greater detail below, the control system 150 can be configured to selectively operate a subset of the switching modules in a bridge circuit to increase the efficiency of the power converter system 100 at low-load conditions.

FIG. 4 depicts a circuit diagram of an exemplary DC to DC converter 110 of the power converter system 100. The DC to DC converter 110 is used to convert the DC power provided by the input power source 102 to a DC power provided to the DC link 120. The DC to DC converter 110 can be a buck converter, a boost converter, or a buck-boost converter 110.

As shown, the DC to DC converter 110 includes a plurality of input bridge circuits 112, 114, and 116 that include power electronic devices that are used to convert power from the input power source to a DC power provided to the DC link 120. Each input bridge circuit 112, 114, and 116 is associated with a different input line from the input power source. For instance, input bridge circuit 112 is associated with the input i₁ from the input power source. Input bridge circuit 114 is associated with the input i₂ from the input power source. Input bridge circuit 116 is associated with the input i₃ from the input power source.

Each input bridge circuit 112, 114, and 116 includes a plurality of switching modules (e.g. IGBT modules) coupled in parallel. For instance, input bridge circuit 132 includes switching modules 112a, 112b, up to 112n switching modules coupled in parallel. Switching module 112n is illustrated in dashed line to represent that any number of switching modules up to 112n can be connected in parallel for each bridge circuit. Similar to input bridge circuit 112, inverter bridge circuit 114 includes switching modules 114a, 114b, up to 114n switching modules coupled in parallel. Input bridge circuit 116 includes switching modules 116a, 116b, up to 116n switching modules coupled in parallel.

Each switching module can include includes a pair of switching elements (e.g. IGBTs) coupled in series with one another. A diode can be coupled in parallel with each of the individual switching elements. The input of the switching module is coupled to the switching module at a location between the pair of switching elements.

As illustrated, each switching module has its own dedicated driver circuit for controlling the switching elements in the switching module. For instance, switching modules 112a, 112b, . . . 112n each have an associated driver circuit 142a, 142b, . . . 142n. Switching modules 114a, 114b, . . . 114n each have an associated driver circuit 144a, 144b, . . . 144n. Switching modules 116a, 116b, . . . 116n each have an associated driver circuit 146a, 146b, . . . 146n.

Each driver circuit can be configured to provide gate timing commands to its associated switching module to achieve a desired output for the DC to DC converter 110. For instance, the driver circuits can be used to implement gate commands from the control system 150 (shown in FIG. 1) to provide a desired DC output voltage to the DC link 120. Similar to the inverter 130 discussed above, the control system 150 can be configured to selectively operate a subset of the switching modules in a bridge circuit of the DC to DC converter 110 to increase the efficiency of the power converter system 100 at low-load conditions.

FIG. 5 depicts a flow diagram of an exemplary method (200) of increasing the efficiency of the power converter at low load conditions for the power converter according to an exemplary aspect of the present disclosure. The method (200) will be discussed with reference to the power converter system 100 illustrated and discussed with reference FIGS. 2-4, however the method (200) can be practiced with any suitable power converter system. In addition, although FIG. 5 depicts steps performed in a particular order for purposes of illustration and discussion, the methods discussed herein are not limited to any particular order or arrangement. One skilled in the art, using the disclosures provided herein, will appreciate that various steps of the methods can be omitted, rearranged, combined and/or adapted in various ways.

At (202) the method includes receiving input power at a power converter from an input power source. For instance, the input power can be provided from a input power source, such as a PV array, to one or more of the input bridge circuits 112, 114, or 116. The input power could also be provided from the DC link 120 to one or more inverter bridge circuits 132, 134, or 136.

At (204), a command is received to operate the power converter at a reduced load condition, such as a load condition that is less than the rated output power for the power converter. The command can be received in any suitable manner. For instance, the command can be input by an operator of the power converter 105 at a user interface (not shown) associated with the control system 150. In addition, the control system 150 can be operated pursuant to a control routine that automatically operates the power converter 105 at a reduced load conditions, such as during sun rise or sun down events.

At (206), the method determines whether the load condition is less than a threshold. For instance, the control system 150 can determine whether the load condition is less than a predefined threshold, such as less than about 50% of the rated output power of the power converter 105. If not, the power converter 105 is operated pursuant to normal operating conditions to convert the input power to AC power at a grid frequency as shown at (210).

If the load condition is less than the threshold, the method includes selectively operating a subset of switching modules for an individual bridge circuit based on the load condition for the power converter (208). The remaining switching modules in the bridge circuit are disabled.

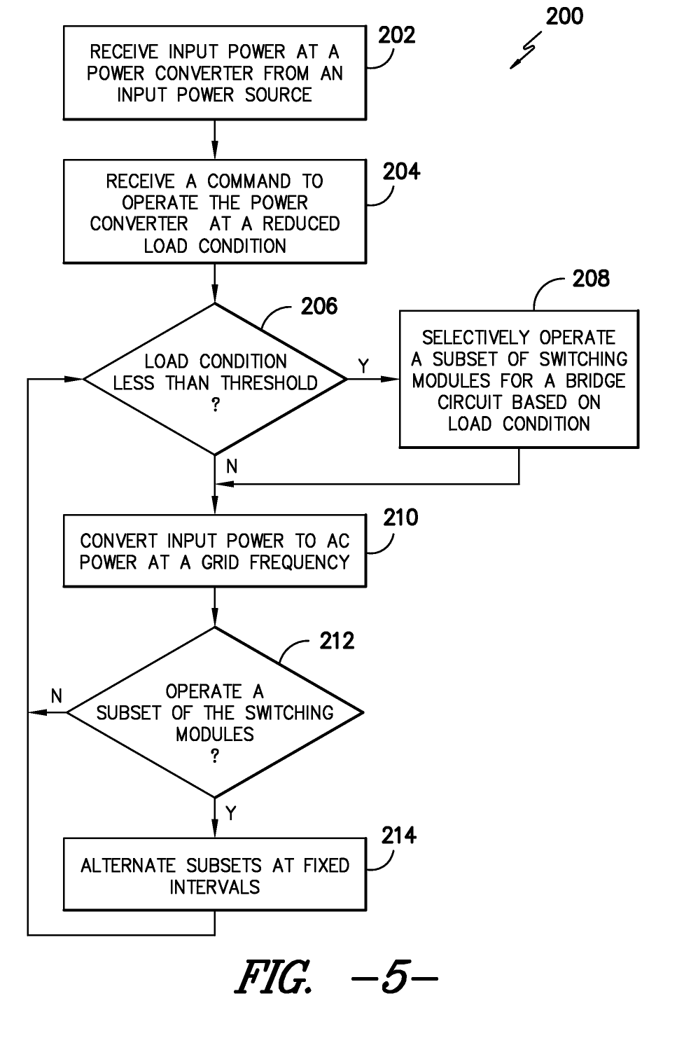

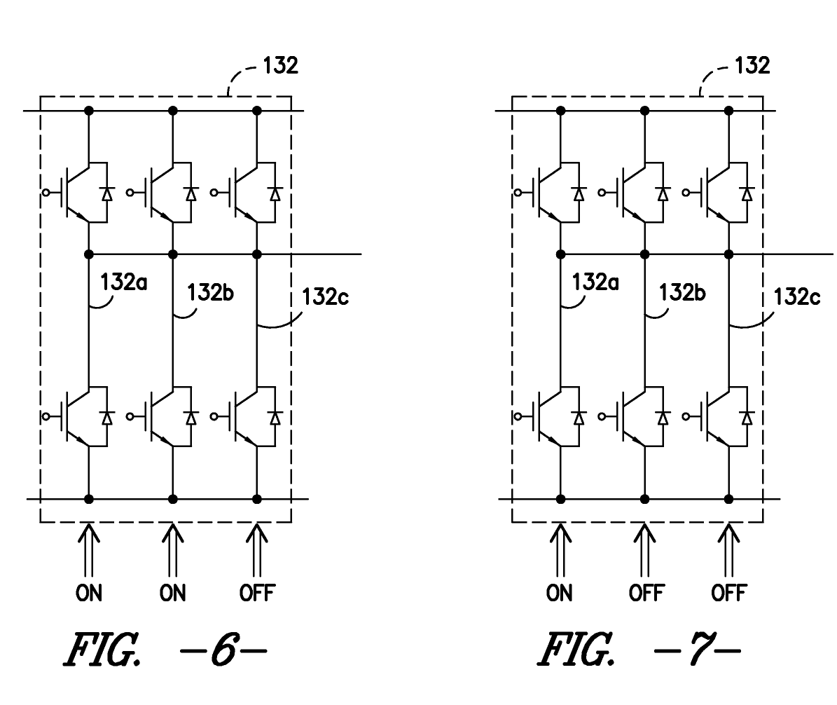

FIGS. 6 and 7 depict the exemplary selective activation of a subset of switching modules for a bridge circuit according to an exemplary aspect of the present disclosure. The bridge circuit depicted in FIGS. 6 and 7 is an exemplary inverter bridge circuit 132 associated with an output phase of the power converter 105. The selective activation of a subset of switching modules can be performed with any bridge circuit of the power converter 105, such as any of the inverter bridge circuits of the inverter 130 or any of the input bridge circuits of the DC to DC converter 110.

The bridge circuit 132 includes three switching modules 132a, 132b, and 132c. As shown in FIG. 6, at a reduced load condition, the control system 150 can selectively operate a subset of the switching modules in the bridge circuit, such as switching modules 132a and 132b. In particular, the control system 150 can provide gate timing commands through independent driver circuits associated with the switching modules to control the duty cycle of switching elements in switching modules 132a and 132b to achieve a desired output at a grid frequency. The switching module 132c can be disabled completely. In other words, no gate timing commands are used to control the modulation of switching module 132c and the switching elements of switching module 132c remain open during operation of the power converter.

FIG. 7 depicts the selective operation of a subset of switching modules in a bridge circuit at an even further reduced load condition. In particular, the control system 150 selectively operates only a single switching module 132a of the plurality of switching modules 132a, 132b, and 132c. Switching modules 132b and 132c are disabled. In this embodiment, the control system is operating about 33% of the switching modules of the bridge circuit 132. While switching module 132a is being selectively activated in FIG. 7, those of ordinary skill in the art, using the disclosures provided herein, will understand that control system could similarly selectively active only switching module 132b or switching module 132c.

According to aspects of the present disclosure, the control system 150 can be configured to selectively activate a subset of switching modules in a bridge circuit based on a load condition associated with power converter. For instance, the control system 150 can be configured to selectively activate a subset of switching modules in a bridge circuit when the power converter is operated at reduced load conditions, such as load conditions of less than about 50% of rated output power for the power converter.

In a particular aspect, the number of switching modules selectively activated during operation of the power converter can be dependent on the load condition for the power converter. For instance, the control system can determine based on a desired load condition the number of switching modules to operate to achieve the load condition. The number of switching modules can be selected to be the number of switching modules that correlates to the desired load condition. As one example, the control system can be configured to operate about 50% or less of the switching modules in a bridge circuit when the load condition of the power converter is at about 50% or less of the rated output power for the power converter. As another example, the control system can be configured to operate about 33% or less of the switching modules in a bridge circuit when the load condition of the power converter is at about 33% or less of the rated output power for the power converter.

In certain cases, the number of switching modules can be selected to be the first integer number of switching modules greater than the load condition for the power converter. For instance, in an example where a bridge circuit includes three switching modules coupled in parallel, the control system can be configured to selectively operate two or less of the switching modules (e.g. about 66% or less of the switching modules) at a load condition of 60%. In an example where a bridge circuit includes six switching modules coupled in parallel, the control system can be configured to selectively operate three or less of the switching modules at a load condition of 50%.

Referring back to FIG. 5, the method converts the input power to AC power 210 at a grid frequency and at a reduced load condition by selectively operating a subset of switching modules in a bridge circuit in accordance with exemplary aspects of the present disclosure. In this manner, the switching losses incurred during operation of the power converter can be reduced, leading to improved efficiency of the power converter at low load conditions.

According to another aspect of the present disclosure, the method at (212) can determine whether the control system is operating a subset of the switching modules of a bridge circuit. If not, the method continues to converter input power to AC power at a grid frequency according to normal operating conditions (210). If a subset of the switching modules is being operated, the method can include alternating the subsets being selectively operated at fixed time intervals as shown at (214).

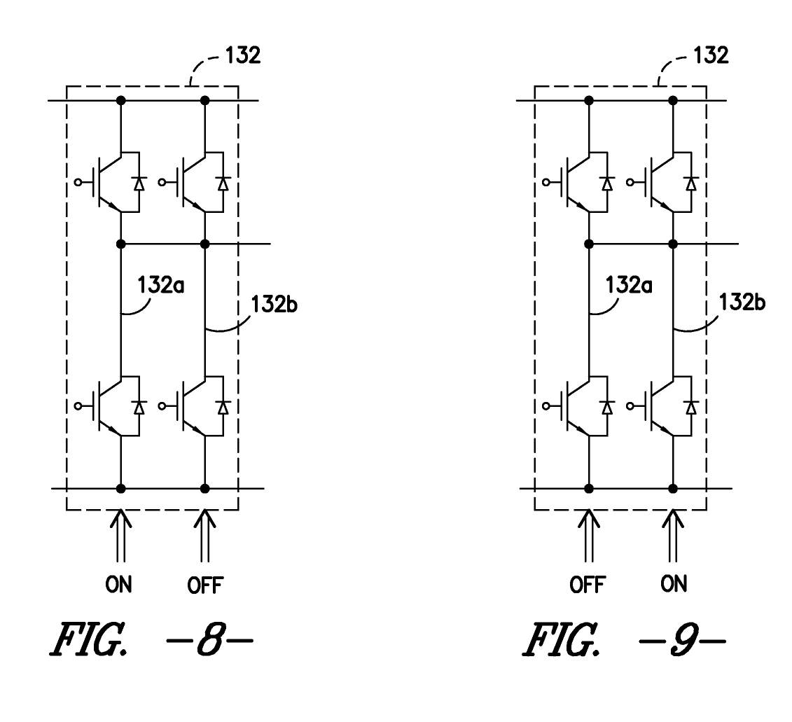

For example, FIGS. 7-8 illustrate the selective operation of a subset of switching modules of a bridge circuit 132 having two switching modules 132a and 132b coupled in parallel. For a first time interval, the control system 150 can selectively operate switching module 132a while switching module 132b is disabled as shown in FIG. 7. For a second time interval, the control system 150 can selectively operate switching module 132b while switching module 132a is disabled. The control system 150 can then alternate between the subsets at fixed time intervals during operation of the power converter at low load conditions.

Selectively operating a subset of the switching modules at low load conditions can improve the efficiency of a power converter at low load conditions. Table I provided below provides the individual efficiency of an exemplary 1 MW solar power converter as a function of output power and the number of parallel switching modules being selectively operated in a bridge circuit.

TABLE I

| Parallel Switching | | | | | | |
|---|---|---|---|---|---|---|
| Modules | 1 MW | 500 KW | 300 KW | 200 KW | 100 KW | 50 KW |
| 6 | 98.099% | 98.392% | 98.328% | 98.108% | 97.263% | 95.874% |
| 3 | 97.761% | 98.243% | 98.271% | 98.113% | 97.381% | 96.006% |
| 1 | 96.344% | 97.543% | 97.871% | 97.874% | 97.338% | 96.032% |

As shown, operating a subset of the switching modules in a bridge circuit can lead to improvements in efficiency a low load conditions. For instance, operating about 50% of the switching modules (e.g. 3 switching modules) at load conditions of 200 KW and 100 KW can lead to efficiency gains. Similarly, operating less than 33% of the switching modules (e.g. 1 switching module) at a load condition of 50 KW can similarly lead to efficiency gains.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A power converter system, comprising:
a power converter couplable to an input power source and configured to generate an output power substantially at a grid frequency, the power converter comprising an inverter bridge circuit associated with an output phase of the power converter, the inverter bridge circuit comprising a plurality of switching modules coupled in parallel; and
a control system configured to control the plurality of switching modules in the at least one bridge circuit, said control system configured to selectively operate a subset of the plurality of switching modules in the inverter bridge circuit based on a load condition for the power converter.

2. The power converter system of claim 1, wherein each of the plurality of switching modules of the inverter bridge circuit comprises a pair of switching elements coupled in series with one another and an output coupled between the pair of switching elements.

3. The power converter system of claim 2, wherein the plurality of switching elements comprise insulated gate bipolar transistors (IGBTs).

4. The power converter system of claim 1, wherein the control system is configured to selectively activate a different subset of the plurality of switching modules after a predetermined time period.

5. The power converter system of claim 1, wherein the control system comprises an independent driver circuit associated with each of the plurality of switching modules.

6. The power converter system of claim 1, wherein the power converter provides a multiphase output power, the power converter comprising an inverter bridge circuit associated with each output phase of the multiphase output power.

7. The power converter system of claim 1, wherein the power converter further comprises an input bridge circuit couplable to the input power source and configured to generate an output DC power to a DC link, the DC link coupling the input bridge circuit to the inverter bridge circuit.

8. The power converter system of claim 7, wherein the input bridge circuit comprises a plurality of switching modules coupled in parallel, the control system configured to selectively activate a subset of the plurality of switching modules in the input bridge circuit based on a load condition of the power converter.

9. The power converter system of claim 1, wherein the control system is configured to selectively activate 50% or less of plurality of switching modules of the inverter bridge circuit at a load condition of 50% or less of a rated output power for the power converter.

10. The power converter system of claim 1, wherein the control system is configured to selectively activate 33% or less of the switching modules of the inverter bridge circuit at a load condition of 33% or less of a rated output power for the power converter.

11. A method of increasing the efficiency of a power converter at a load condition that is less than the rated output power for the power converter, the method comprising:
providing an inverter input to an inverter bridge circuit of the power converter, the inverter bridge circuit associated with an output phase of the power converter and comprising a plurality of switching modules connected in parallel;
converting the inverter input to an output power substantially at a grid frequency and at the load condition that is less than the rated output power for the power converter;
wherein converting the inverter input to an output power at a load condition that is less than the rated output power for the power converter comprises selectively operating a subset of the plurality of switching modules of the inverter bridge circuit.

12. The method of claim 11, wherein method further comprises selectively activating a different subset of the plurality of switching modules of the inverter bridge circuit after a predetermined time period.

13. The method of claim 11, wherein the method comprises:
providing an input to an input bridge circuit of the power converter, the input bridge circuit comprising a plurality of switching modules connected in parallel; and
converting the input to a DC power provided to a DC link, the DC link coupling the input bridge circuit and the inverter bridge circuit such that the DC power is the inverter input to the inverter bridge circuit;
wherein converting the input to a DC power provided to a DC link comprises selectively activating a subset of the plurality of switching modules of the input bridge circuit.

14. The method of claim 11, wherein the method comprises selectively activating 50% or less of the plurality of switching modules of the inverter bridge circuit at a load condition of 50% or less of the rated output power for the power converter.

15. The method of claim 11, wherein the method comprises selectively activating 33% or less of the plurality of switching modules of the inverter bridge circuit at a load condition of 33% or less of the rated output power for the power converter.

16. A power converter system, comprising:
at least one input bridge circuit couplable to an input power source, the input bridge circuit comprising a plurality of switching modules coupled in parallel;
at least one inverter bridge circuit coupled to the at least one input bridge circuit by a DC link; the at least one inverter bridge circuit configured to provide an output phase of the power converter, the at least one inverter bridge circuit comprising a plurality of switching modules coupled in parallel;
a control system configured to selectively operate a subset of the plurality of switching modules of the at least one input bridge circuit or the at least one inverter bridge circuit to provide an output power at a load condition that is less than the rated output power for the power converter to improve the efficiency of the power converter system at the load condition that is less than the rated output power for the power converter.

17. The power converter system of claim 16, wherein the control system is configured to selectively activate a different subset of the plurality of switching modules of the at least one input bridge circuit or the at least one inverter bridge circuit after a predetermined time period.

18. The power converter system of claim 16, wherein the control system comprises an independent driver circuit associated with each of the plurality of switching modules of the input bridge circuit and the inverter bridge circuit.

19. The power converter system of claim 16, wherein the control system is configured to selectively activate 50% or less of plurality of switching modules of the input bridge circuit or the inverter bridge circuit at a load condition of 50% or less of the rated output power for the power converter.

20. The power converter system of claim 16, wherein the control system is configured to selectively activate 33% or less of the switching modules of the input bridge circuit or the inverter bridge circuit at a load condition of 33% or less of the rated output power for the power converter.
